(19) United States
(12) Patent Application Publication
(10) Pub. No.: US 2010/0076856 A1
(43) Pub. Date: Mar. 25, 2010

(54) Real-Time Auction of Cloud Computing Resources

(75) Inventor: Christopher Lee Mullins, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/237,813

(22) Filed: Sep. 25, 2008

(51) Int. Cl. G06Q 30/00; G06Q 50/00

(52) U.S. Cl. 705/26

(57) ABSTRACT

A cloud computing environment may be built out with cloud computing resources in geographically separate regions. An auction process may be used to ensure that the cloud computing resources are utilized at an optimal level on both a per-region basis and global basis. Computing resource auction prices may reflect local peak and off-peak pricing while offering buyers access to off-peak computing from peak-usage regions at some risk of latency or network outages. Long-running jobs may bid for execution resources on a global basis and move execution to follow low cost availability through, for example, off-peak local hours.

### BACKGROUND

Commodities, such as food and energy, must be traded in view of actual production and the realities of delivery cost and timeliness for worldwide markets.

### SUMMARY

A platform for trading cloud or grid computing resources allows both spot and futures market trading for global computing capacity reflecting the capacity of cloud computing and delivery characteristics of both the Internet and other network implementations. In a distributed marketplace, global capacity utilization can be balanced by auctioning off-hours market capacity, balanced against the risk of latency, communication interruptions, etc. For long-running jobs, execution may be moved globally through the day as local rates and availability meet economic and reliability targets. One trading model may set floor prices based on historical computing trends, resource utilization targets, economic factors, etc. Further, construction of new capacity may be based on trend analysis and futures pricing. Alternatively, cost and profitability targets can be used to cut back capacity when an oversupply condition develops.

### BRIEF DESCRIPTION OF THE DRAWINGS

FIG. 1 is a block diagram of representative cloud computing environment;

FIG. 2 is a block diagram of a general purpose computing device; and

FIG. 3 is a flow chart of a method auctioning cloud computing resources.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

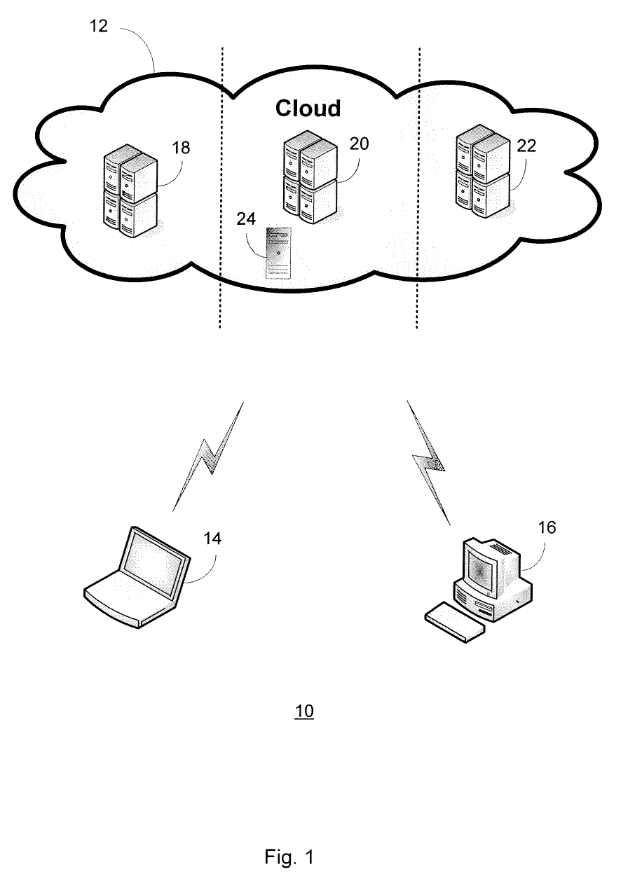

FIG. 1 illustrates a computing domain 10 including a cloud computing environment 12 and users 14 and 16.

The cloud computing environment 12 may include geographically separate computing resources 18, 20, and 22. The computing resources may be spaced worldwide, such as in North America, Europe, and Asia, to ensure that ‘prime time’ computing resources are available throughout any 24 hour period. A potential advantage of using prime time resources may be better support and response time to issues, should the arise. A potential advantage of using more local resources may be response time and higher reliability network facilities. Additionally, power consumption often is priced as a function of time, and a geo-scale cloud network may choose to minimize power costs. A moderator 24 may manage an auction process for sale of processing time on any of the computing resources 18, 20, 22. The moderator 24 may also allocate computing resources to the winner of the auction process. In other embodiments, the moderator 24 may be an application supported on one or more computing resources in the cloud computing environment 12.

In operation, a user 14 may determine a need for computing resources, for example, running a payroll job or support for a website, although other scenarios abound. The user 14 may place a bid on computing resource usage in general or choose a specific computing resource 18, 20, 22. The user 14 may also choose to purchase usage at a future date or at a particular time of day.

The moderator 24 (or equivalent function) may set a floor price for each usage time period for each computing resource 12, 18, 22. The floor price may be adjusted according to trends of previous use or may be set according to a profitability target of the cloud computing environment 12.

Another use of setting floor prices is to offset availability due to unforeseen external influences, such as a local physical or economic factor. Examples may include local disasters (natural or otherwise), or local legal requirements (such as “no smog” as was recently enforced in China during the Olympics). When capacity is difficult to provide or a cut back in capacity is required, the spot price can simply be increased until the desired usage is achieved when jobs move to other, cheaper locations.

When capacity exceeds demand, available cloud computing resources may be managed to maximize profit targets and sales models. For example, cloud resources may be enabled or disabled based on utilization to meet business targets. In another example, unused capacity may be turned off to minimize datacenter costs, based on both customer utilization, and time of day, e.g. turn off unused resources at night.

In another embodiment, turning off capacity may be used to force users to a “cheaper” resource. For example, peak hour electricity may be very expensive at some locations, so when a cost of production exceeds a target value, users are better diverted to an off-peak datacenter.

In one broad embodiment, support is provided for auctioning an arbitrary resource in the cloud computing environment in an arbitrary geographic region at the arbitrary time of day at the given price. In this embodiment, a user may bid on any computing resource located anywhere, anytime. It is anticipated that cloud computing environments will eventually expand into space, where super conducting cold environments are easily maintained and communication capacity will make such a space-based platform cost effective. Thus, it is safe to envision an embodiment where such an arbitrary geographic region will not be confined to a terrestrial location.

In one embodiment, local time zone peak usage hours for a particular computing resource, e.g. computing resource 18 may demand a higher price than off-peak usage hours. For users willing to use out-of-area computing resources, at the risk of higher latency or communication interruptions, the price may be lower than a comparable local peak price. Additionally, a datacenter may bring additional resources online based on time-centric model, with potentially more computing power “available” during the day (or night), and pricing calculated accordingly.

In another embodiment, a floor price for auctioning a resource may be made when the purchaser will realize a related advantage, such as a favorable legal condition. The favorable legal conditions may include a tax advantage, such as having work performed outside the U.S. or EU. In other examples, the legal condition may be related to data privacy or data retention rules.

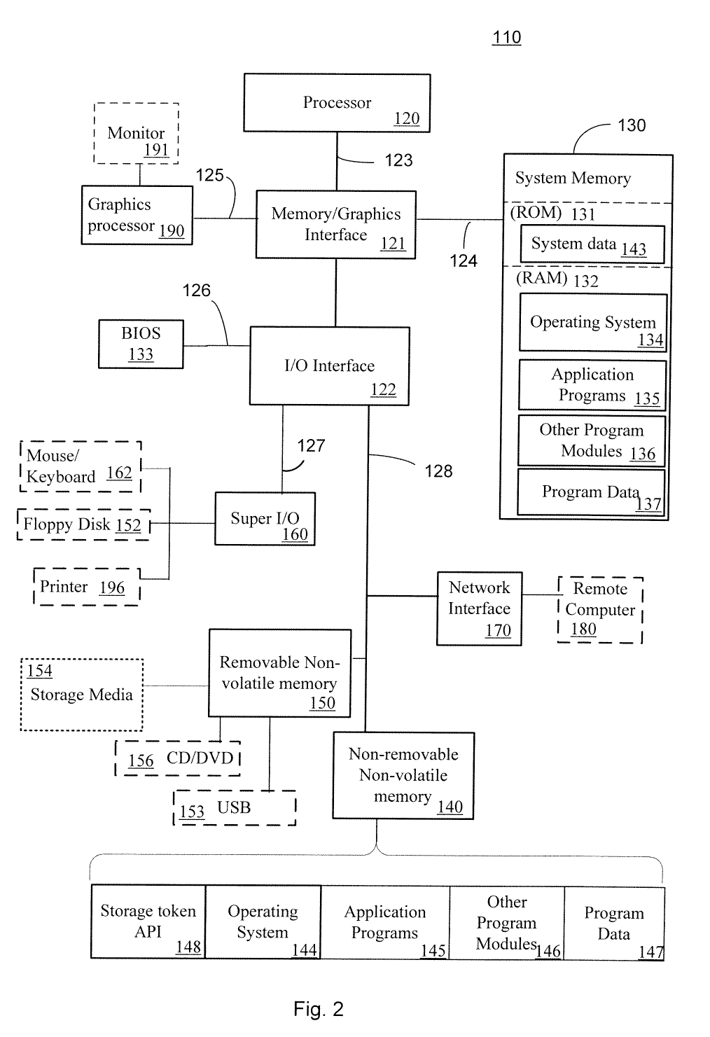

With reference to FIG. 2, an exemplary system for implementing the claimed method and apparatus includes a general purpose computing device in the form of a computer 110. Components shown in dashed outline are not technically part of the computer 110, but are used to illustrate the exemplary embodiment of FIG. 2. Components of computer 110 may include, but are not limited to, a processor 120, a system memory 130, a memory/graphics interface 121, also known as a Northbridge chip, and an I/O interface 122, also known as a Southbridge chip. The system memory 130 and a graphics processor 190 may be coupled to the memory/graphics interface 121. A monitor 191 or other graphic output device may be coupled to the graphics processor 190.

A series of system busses may couple various system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport™ architecture, respectively.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 2 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

A super input/output chip 160 may be used to connect to a number of ‘legacy’ peripherals, such as floppy disk 152, keyboard/mouse 162, and printer 196, as examples. The super I/O chip 160 may be connected to the I/O interface 122 with a bus 127, such as a low pin count (LPC) bus, in some embodiments. Various embodiments of the super I/O chip 160 are widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

The computer 110 may also include other removable/non-removable, volatile/nonvolatile computer storage media. By way of example only, FIG. 2 illustrates a hard disk drive 140 that reads from or writes to non-removable, nonvolatile magnetic media. The hard disk drive 140 may be a conventional hard disk drive or may be similar to the storage media described below with respect to FIG. 2.

Removable media, such as a universal serial bus (USB) memory 153, firewire (IEEE 1394), or CD/DVD drive 156 may be connected to the PCI bus 128 directly or through an interface 150. A storage media 154 similar to that described below with respect to FIG. 2 may coupled through interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 110. In FIG. 2, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a mouse/keyboard 162 or other input device combination. Other input devices (not shown) may include a microphone, joystick, game pad, satellite dish, scanner, or the like. These and other input devices are often connected to the processor 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection between the NIC 170 and the remote computer 180 depicted in FIG. 2 may include a local area network (LAN), a wide area network (WAN), or both, but may also include other networks. Such networking environments are commonplace in offices, enterprise-wide computer networks, intranets, and the Internet. The remote computer 180 may also represent a computer in a cloud computing environment or a user computer interacting with a cloud computing resource.

In some embodiments, the network interface may use a modem (not depicted) when a broadband connection is not available or is not used. It will be appreciated that the network connection shown is exemplary and other means of establishing a communications link between the computers may be used.

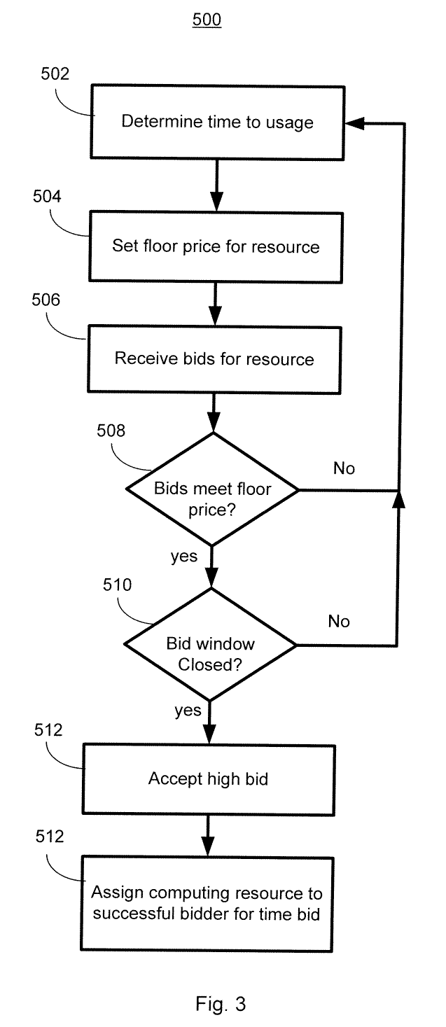

FIG. 3 illustrates a method 500 of auctioning resources in a cloud computing environment 12. One goal of the auction process is to create an optimal level of resource usage according to available resources and target profitability. Trends can be analyzed to set floor (i.e. minimum) prices for designated usage periods, for example, if web server usage is typically high in the second half of November, a high floor price may be set for that period.

Trend analysis may also be used to determine capacity build out requirements. Because a cloud computing environment, such as environment 12, may present resources as a single parcel or as geographically separated resources 18, 20, 22, auctions may also reflect usage at peak and off-peak local usage times. For example, noon in London, a peak usage period, corresponds to an off-peak 8:00 pm in Beijing. A user may bid for time in either or both geographic zones to allow for cheap backup computing or to allow moving a job from one low cost region to another as a current off-peak location moves during the day.

At block 502, a cloud computing environment 12 may be provided and a period of time until the resource period at auction may be determined. More than one resource in different geographic regions may be at auction. For the case of the current example, a 3 month out period of computing time may be at question. At block 504, a floor price representing a minimum target price may be set. The floor price may be set according to a historical use pattern, a profitability target, a combination of the two, or other factor. For example, if the period in question typically has a high level of volatility, the floor price may be set high to preserve uncommitted time. In another embodiment, the floor price may be dynamically adjusted to follow a model of sold capacity and time to use. For example, if demand for a particular time slot and geographic region is low, the floor price may be lowered until the sold capacity reaches a target level for the number of days until use.

At block 506, auction bids for use of a first resource in a first geographic region for a first time of day may be accepted and auction bids for use of a second resource in second geographic region at the same time of day may also be accepted. That is, bidders may bid for simultaneous use of resources in two different regions, for example, one peak time and one off-peak time, although other combinations may exist, for example, two off-peak geographies may be bid, anticipating movement of a job as one region becomes more expensive during the course of the day. The auctions may follow known patterns. For example, one format of bidding may accept variable bids for a fixed amount of computing resource, while another format may have a set fee and bids are placed for a variable amount of computing resource. Many auction types are also allowed, such as (but not limited to) Dutch Auctions, Reverse Dutch Auctions, or Sealed Bid Auctions,

At block 508, the bids received at block 506 may be analyzed to see if they meet the floor price for the resource. If not, the ‘no’ branch from block 508 may be taken to block 502, where the new time to use may be determined and the process restarted.

If, at block 508, at least one bid meets the floor price, the ‘yes’ branch from block 508 may be taken to block 510.

At block 510, a determination may be made to as to whether a bid period has closed. For example, a cloud computing environment provider may auction 3 month futures for 20% of the cloud capacity for some future date. The bidding may close at a pre-announced time, for example, 6 weeks before the usage date. Other embodiments may allow bidding in virtually real time for cloud computing environment resources. Bids may also close as a function of bidder count, with an auction remaining open while an insufficient number of bids have been solicited.

If bidding is not closed, the ‘no’ branch may be taken to block 502 and the process restarted.

If bidding is closed, the ‘yes’ branch may be taken to block 512 and the highest bid maybe accepted. Bids for the first and second resources may be closed at the same time. In one embodiment, both floor prices and bid prices for the two geographic regions may be different.

At block 514, the winning bidder(s) may receive access to the computing resource or resources in question. In a variation of the above process, bidding may continue for use of the first resource at a second time of day, for example, providing a hedge against a computing requirement extending past the originally bid-for time slot.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of allocating resource usage in a cloud computing environment comprising:
providing the cloud computing environment;
auctioning a first resource in the cloud computing environment in a first geographic region for use at a first time of day at a first price; and
auctioning a second resource in the cloud computing environment in a second geographic region at the first time of day at a second price.

2. The method of claim 1, wherein auctioning the first resource comprises setting a floor price corresponding to a historical trend for usage.

3. The method of claim 1, wherein auctioning the first resource comprises setting a floor price corresponding to a profitability model.

4. The method of claim 1, wherein auctioning the first resource comprises auctioning use of the first resource at a future date.

5. The method of claim 4, further comprising building cloud computing resources corresponding to purchased usage at the future date.

6. The method of claim 1, wherein auctioning the first resource comprises setting a floor price corresponding to a current sales level and a utilization target.

7. The method of claim 1, further comprising:
auctioning the first resource in the cloud computing environment in the second geographic region for use at a second time of day at a third price; and
moving execution of a computing job from the first geographic region to the second geographic region corresponding to a lowest price of execution of the computing job.

8. The method of claim 1, further comprising:
setting a floor price for auctioning the first resource to accommodate one of a local physical factor and a local economic factor.

9. The method of claim 1 further comprising:
setting a floor price for auctioning the first resource according to a favorable legal condition, the favorable legal condition comprising one of a tax advantage, a privacy advantage, and a data storage advantage.

10. A system for supporting cloud computing auctions comprising:
a first computing resource in a first geographic region;
a second computing resource in a second geographic region;
a moderator for managing auction bidding for the first and second computing resources and for allocating access to the computing resources to a successful bidder.

11. A method of managing available cloud computing resources to maximize profits comprising:
enabling cloud resources to match demand.

12. The method of claim 11, further comprising:
disabling cloud resources at a location when a cost of production exceeds a target value.
